(19) United States
(12) Patent Application Publication
(10) Pub. No.: US 2024/0138582 A1
(43) Pub. Date: May 2, 2024

(54) SYNCHRONIZATION OF PRESSURIZATION WITH ARRANGEMENT OF ADJUSTABLE PLATFORM

(71) Applicant: Purple Innovation, LLC, Lehi, UT (US)

(72) Inventor: James Grutta, Draper, UT (US)

(21) Appl. No.: 17/978,141

(22) Filed: Oct. 31, 2022

(51) Int. Cl. A47C 27/08; A47C 27/10; A61G 7/015

(52) U.S. Cl. CPC A47C 27/083; A47C 27/082; A47C 27/10; A61G 7/015; A61G 2203/42

(57) ABSTRACT

An adjustable bed includes an adjustable base and a mattress with a pressurizable layer that includes a plurality of pressurizable sections. Each pressurizable section corresponds to a section of a platform of the adjustable base. As the platform changes an orientation of one or more pressurizable sections, pressure within each pressurizable section may be substantially maintained or adjusted to an orientation-specific pressure. Methods for adjusting pressure within pressurizable sections of a pressurizable layer of a mattress of an adjustable bed are also disclosed.

### TECHNICAL FIELD

This disclosure relates generally to adjusting the air within one or more pressurizable sections of a pressurizable layer of a mattress and, more specifically, to automatically adjusting the air within one or more pressurizable sections of the pressurized layer. Even more specifically, this disclosure relates to automatically adjusting an amount (e.g., a mass, etc.) of air within various pressurizable sections of a pressurizable layer of a mattress in response to movement of the mattress in a manner that changes a volume within one or more of the pressurizable sections (e.g., based on an arrangement an adjustable base (i.e., foundation, platform) that supports the mattress, etc.).

### SUMMARY

In various aspects, systems and methods that synchronize pressurization of different pressurizable sections of a pressurizable layer of a mattress of an adjustable bed with an arrangement of the mattress by an adjustable platform of the adjustable bed are disclosed. Such synchronization may include automatic adjustment of air within one or more pressurizable sections of a pressurizable layer of a mattress (e.g., within the mattress) in response to an arrangement of the mattress upon an adjustable base (i.e., foundation, platform). More specifically, an amount (e.g., a mass, etc.) of air within one or more of the pressurizable sections of the pressurizable layer of the mattress may be automatically adjusted (e.g., increased, decreased) to maintain a substantially constant predetermined pressure within each pressurizable section of the pressurizable layer of the mattress and/or maintain a substantially constant feel (e.g., firmness, softness, etc.) of a corresponding section of the mattress as the adjustable base moves the mattress. The predetermined pressure of each pressurizable section of the pressurizable layer and/or the feel of each corresponding section of the mattress may be maintained regardless of how the mattress is arranged (e.g., in a first arrangement, in a second arrangement, in a third arrangement, etc.) and, more specifically, regardless of how the pressurizable sections of the pressurizable layer of the mattress are arranged relative to each other. Alternatively, the pressure within each pressurizable section of the pressurizable layer of the mattress may be a function of an orientation of that pressurizable section and/or an orientation of one or more other pressurizable sections of the pressurizable layer of the mattress.

An adjustable bed according to this disclosure includes an adjustable base, a mattress, and a main processor.

The adjustable base may include a platform with a plurality of movable sections whose orientations may be changed, or moved, and that may move relative to one another. In a specific embodiment, the movable sections of the platform of the adjustable base may include a body section and at least one leg section. In some such embodiments, the adjustable base may include a body section, an upper leg section, and a lower leg section.

The mattress may be positioned on the platform of the adjustable base. The mattress comprises a pressurizable layer that may include a plurality of pressurizable sections (e.g., air bladders, etc.) along its length. Each pressurizable section of the pressurizable layer may be pressurized (i.e., inflated and deflated) independently of pressurization of every other pressurizable section of the pressurizable layer. Each pressurizable section of the pressurizable layer of the mattress may correspond to and have a configuration that enables it to be positioned over a corresponding movable section of the platform of the adjustable base. More specifically, each pressurizable section of the pressurizable layer of the mattress may have approximately the same shape and occupy substantially the same surface area as, or have substantially the same footprint as, its corresponding movable section of the platform of the adjustable base. As used in reference to “surface area” and “footprint,” the phrase “substantially the same” accounts for acceptable differences (e.g., up to 3 inches or 8 cm in length or width, up to 2 inches or 5 cm in length or width, etc.) between the surface areas or footprints of a pressurizable section of the pressurable layer and its corresponding movable section of the platform. In embodiments where the adjustable base includes a body section and at least one leg section, the pressurizable layer of the mattress may include corresponding body and leg sections.

The main processor of the adjustable bed may control operation of a pressurization system (e.g., a pump, one or more valves, etc.) of the adjustable bed and, thus, an amount of air within each pressurizable section of the pressurizable layer of the mattress based on an orientation of its corresponding movable section of the platform of the adjustable base. In this regard, the main processor may control an amount of air within each pressurizable section to maintain or substantially maintain a pressure of each pressurizable section of the pressurizable layer of the mattress (e.g., within a predetermined threshold of 10% or less, within a predetermined threshold of 5% of less, within a predetermined threshold of 2% of less, etc.) and/or a feel of each corresponding section of the mattress upon movement of at least one movable section of the platform of the adjustable base.

Alternatively, the main processor may adjust an amount of air within at least one pressurizable section of the pressurizable layer of the mattress to place the pressurizable section in preprogrammed pressurized state corresponding to a position of a corresponding movable section of the platform of the adjustable base; thus, the pressure within a pressurizable section may vary depending upon the orientation of the pressurizable section. For example, the pressure of a pressurizable section may undergo a first change (e.g., an increase or a decrease from a set pressure) as the pressurizable section moves from a more reclined orientation to a more inclined orientation. Conversely, the pressure of the pressurizable section may undergo an opposite, second change (e.g., a decrease or an increase from the set pressure) as the pressurizable section moves from a more inclined orientation to a more reclined orientation. As another example, a pressurizable section of the mattress may have a plurality of orientation-dependent predetermined pressures and, thus, a pressure of the pressurizable section may change from one pressure to another pressure as the pressurizable section moves from one orientation to another orientation.

As yet another option, a pressurizable section of the pressurizable layer the mattress may have a plurality of predetermined pressures that depend upon both an orientation of the pressurizable section and the orientation of at least one other pressurizable section (e.g., at least one adjacent pressurizable section, etc.) of the pressurizable layer of the mattress.

A wireless transceiver with an associated antenna may be associated with the main processor of the adjustable bed in a manner that enables the main processor to communicate with a processor of a portable electronic device (e.g., a smart phone, a tablet computer, a smart watch, etc.). The processor of the portable electronic device may execute a bed control app, which may enable an individual to use the portable electronic device to control operation of the adjustable bed.

A method for pressurizing an adjustable bed includes changing an orientation of at least one movable section of a platform of an adjustable bed frame and adjusting an amount (e.g., a mass, etc.) of air within at least one pressurizable section (e.g., air bladder, etc.) of a pressurizable layer of a mattress carried by a platform of the adjustable bed frame. The amount (e.g., mass, etc.) of air within the at least one pressurizable section and, thus, an air pressure within the at least one pressurizable section may correspond to a position in which the at least one movable section of the platform of the adjustable bed frame is moved. In some embodiments, adjusting the amount of air within one or more pressurizable sections of the pressurizable layer of the mattress comprises maintaining or substantially maintaining a pressure of the pressurizable section(s) of the pressurizable layer and/or a feel of the corresponding section(s) of the mattress while moving the at least one movable section of the platform of the adjustable bed frame. In other embodiments, adjusting the amount of air within one or more pressurizable sections of the pressurizable layer of the mattress comprises placing the pressurizable section(s) in one or more preprogrammed pressurized states corresponding to positions of the movable sections of the adjustable base (e.g., adjusting pressure from a set pressure based on an extent to which the pressurizable section is reclined/inclined, adjusting pressure to a predetermined pressure that corresponds to a particular orientation of the pressurizable section and/or another pressurizable section, etc.). Adjustment of the amount of air within a pressurizable section may be automatic.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

In the drawings:

FIG. 1 is perspective view of an embodiment of an adjustable bed that includes an embodiment of a mattress with a pressurizable layer including a plurality of pressurizable sections and an embodiment of an adjustable base with a platform including a plurality of adjustable sections;

FIG. 2 provides a top view representation of the embodiment of the mattress shown in FIG. 1;

FIG. 3 provides a cross-sectional representation of the embodiment of the mattress shown in FIG. 1;

FIG. 4 provides a schematic representation of an embodiment of a pressurization system for controlling pressurization of the pressurizable sections of the pressurizable layer of the embodiment of the mattress shown in FIG. 1;

FIG. 5 is a perspective view of an embodiment of an adjustable base of the embodiment of the adjustable bed shown in FIG. 1;

FIG. 6 provides a schematic representation of the interaction between various components of the embodiment of the adjustable base shown in FIG. 5;

FIG. 7 provides a schematic representation of the interaction between a portable electronic device, the mattress, and the adjustable base of the embodiment of the adjustable bed shown in FIG. 1;

FIG. 8 is a side view of the embodiment of the adjustable bed of FIG. 1, showing an adjustable base and a mattress of the adjustable bed in a first arrangement;

FIG. 9 is another side view of the embodiment of the adjustable bed of FIG. 1, showing the adjustable base and mattress of the adjustable bed in a second arrangement; and

FIG. 10 is yet another side view of the embodiment of the adjustable bed of FIG. 1, showing the adjustable base and mattress of the adjustable bed in a third arrangement.

### DETAILED DESCRIPTION

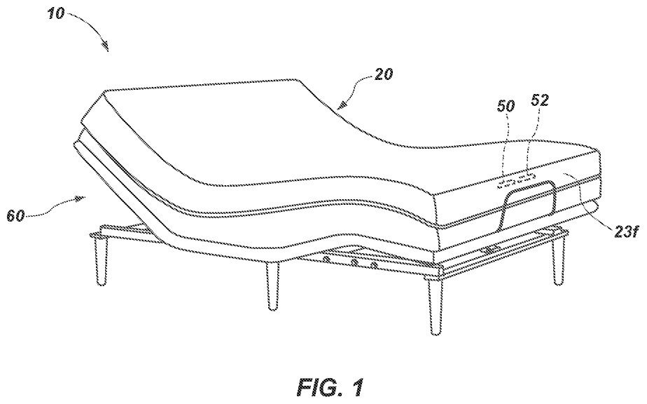

FIG. 1 illustrates an embodiment of an adjustable bed 10. The adjustable bed 10 includes a mattress 20, a main processor 50, at least one wireless transceiver 52 with an associated antenna (not shown), and an adjustable base 60.

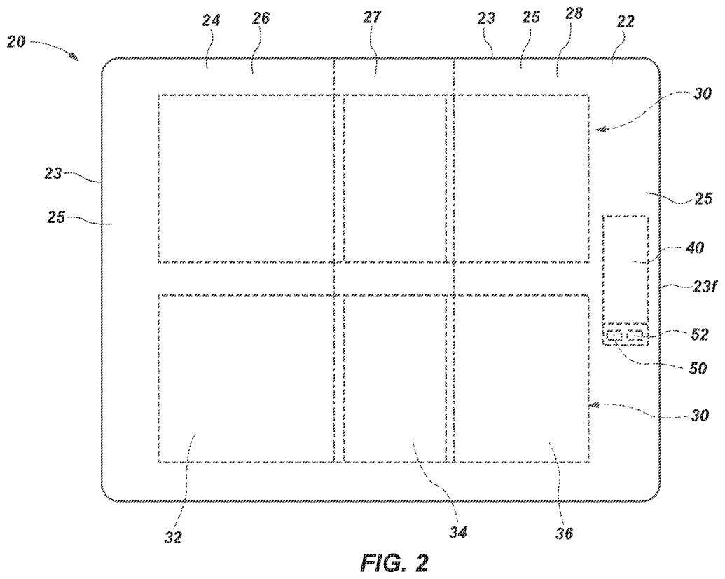

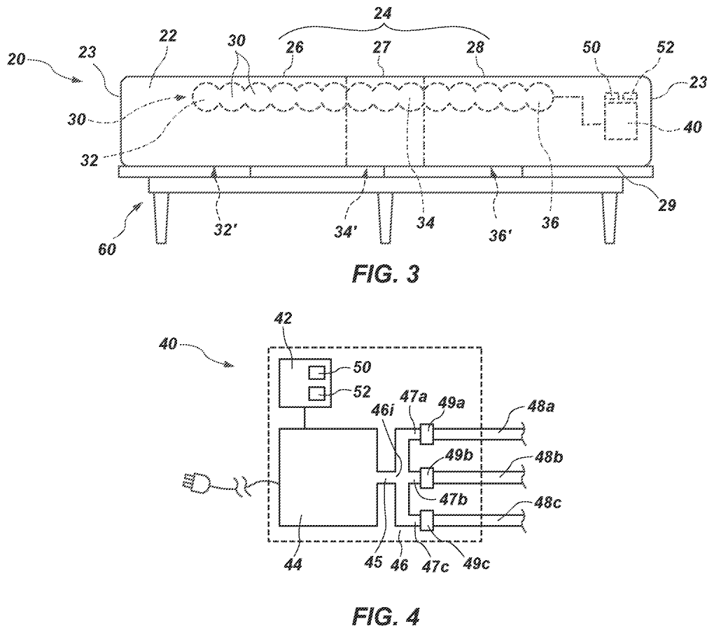

Turning to FIGS. 2 and 3, the mattress 20 of the adjustable bed 10 may have any suitable shape and dimensions and may include a cover 22 that contains various internal elements (some of which are not shown) of the mattress 20. The mattress 20 may include edges 23, a top surface, or sleep surface 24, between top ends of the edges 23, and a bottom surface, or base 29, between bottom ends of the edges 23. The sleep surface 24 of the mattress 20 may be configured to be slept on by one or more individuals. The sleep surface 24 may include edges 25 at locations adjacent to side edges 23 of the mattress 20, a head portion 26, an intermediate portion 27, and a foot portion 28.

Internally, the mattress 20 may include one or more pressurizable layers 30. Each pressurizable layer 30 may include pressurizable sections 32, 34, 36 that may be pressurized independently of one another. Each pressurizable section 32, 34, 36 of the pressurizable layer 30 may be located within a corresponding section 32′, 34′, 36′ of the mattress 20 and, thus, render the corresponding sections 32′, 34′, 36′ of the mattress 20 independently pressurizable from each other. U.S. patent application Ser. No. 17/682,649, the entire disclosure of which is hereby incorporated herein, discloses a type of pressurizable layer 30 that may be included in the mattress 20.

The mattress 20 may comprise any suitable type of pressurizable mattress, including, without limitation, a mattress that also includes a gel grid (e.g., those available from Purple Innovation, LLC, of Lehi, Utah and disclosed by U.S. Pat. Nos. 7,060,213, 7,076,822, and 8,919,750, which may be formed from any suitable material, including, but not limited to, an extended A-B-A triblock copolymer, such as those disclosed by U.S. Pat. Nos. 6,413,458, 6,797,765 and 7,964,664; the entire disclosures of each of the foregoing patents are hereby incorporated herein). Various specific but nonlimiting embodiments of such a mattress are disclosed by U.S. Pat. No. 11,213,139, the entire disclosure of which is hereby incorporated herein.

A pressurization system 40 may be associated with the pressurizable layer 30 of the mattress 20. In some embodiments, the pressurization system 40 may be carried by the mattress 20 or by the adjustable base 60. In some embodiments where the pressurization system 40 is carried by the mattress 20, the pressurization system 40 or a portion thereof may be carried within the mattress 20 (e.g., adjacent to a foot edge 23f of the mattress 20; etc.).

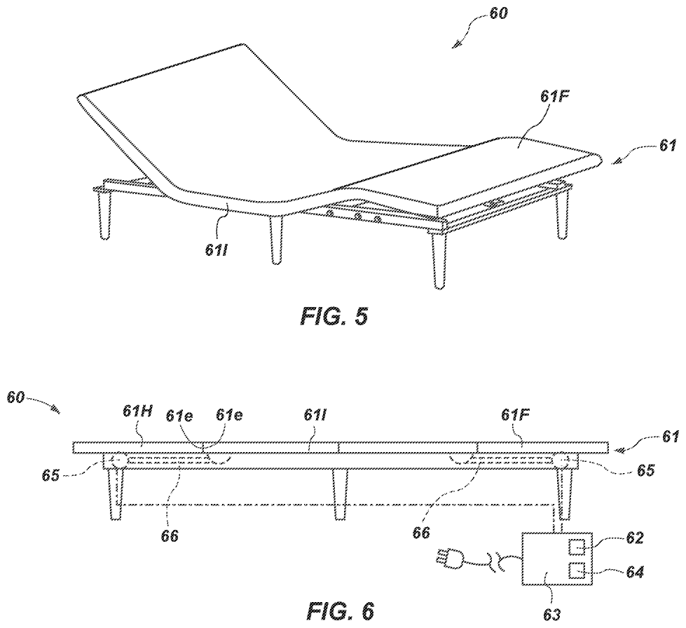

As represented by FIG. 4, the pressurization system 40 may include electronics 42, at least one pressure source 44 (e.g., an air compressor, etc.), and a conduit 45 extending from each pressure source 44. The electronics 42 may receive power from a power supply (e.g., electronics 62 of the adjustable base 60 (see FIG. 5); mains power, etc.) in a manner known in the art and communicate the power in a manner that enables other components of the pressurization system 40 and, optionally, the mattress 20 or even the adjustable bed 10 (e.g., the pressure source 44; valves 49a, 49b, etc., if any; the main processor 50; the transceiver(s) 52; etc.) to function. The electronics 42 of the pressurization system 40 may communicate with the main processor 50 of the adjustable bed 10; in such embodiments, the main processor 50 may control operation of the other components of the pressurization system 40.

Each pressure source 44 of the pressurization system 40 may pressurize a fluid (e.g., it may generate air pressure, etc.). The pressure may be conveyed through the conduit 45 to at least partially communicate the pressure to one or more pressurizable sections 32, 34, 36 of the pressurizable layer 30.

In embodiments where the number of pressure sources 44 of the pressurization system 40 (e.g., one, etc.) is less than the number of pressurizable sections 32, 34, 36 of the pressurizable layer 30 (e.g., three, etc.), the pressurization system 40 may include a manifold 46 that receives pressure from the conduit 45. The manifold 46 may include an inlet 46i and a plurality of outlets 47a, 47b, etc. A conduit 48a, 48b, etc. may be coupled to each outlet 47a, 47b, etc. of the manifold 46, extend to a corresponding pressurizable section 32, 34, 36 of the pressurizable layer 30, and communicate with an interior of its corresponding pressurizable section 32, 34, 36. A valve 49a, 49b, etc. may be associated with each outlet 47a, 47b, etc. of the manifold 46 or with each conduit 48a, 48b, etc. Operation of the valves 49a, 49b, etc. (e.g., opening a valve 49a, 49b, etc.) while operating a pressure source 44 associated with the manifold 46 may enable pressurized air to be communicated through a corresponding outlet 47a, 47b, etc. and a corresponding conduit 48a, 48b, etc. in a manner that increases a pressure (e.g., an air pressure, etc.) within a corresponding pressurizable section 32, 34, 36 of the pressurizable layer 30. Operation of the valves 49a, 49b, etc. (e.g., opening a valve 49a, 49b, etc.) without operating the pressure source 44 may enable pressure (e.g., air, etc.) to be released from a corresponding pressurizable section 32, 34, 36 of the pressurizable layer 30 in a manner that decreases a pressure within the corresponding pressurizable section 32, 34, 36.

With returned reference to FIG. 1, the main processor 50 of the adjustable bed 10 may comprise one or more processing elements of a suitable type. In some embodiments, the main processor 50 may comprise one or more microcontrollers, which may execute embedded programming (e.g., firmware) to control one or more dedicated functions. The main processor 50 may be carried by the mattress 20 (e.g., internally, adjacent to a foot edge 23f of the mattress 20; etc.), the adjustable foundation 60 of the adjustable bed 10, or elsewhere.

The at least one wireless transceiver 52 of the adjustable bed 10 may comprise one or more of a WiFi transceiver, a Bluetooth® transceiver, a near-field communication (NFC) (e.g., radiofrequency (RF), etc.) transceiver, a 2.4 GHz RF transceiver, or the like, along with its associated antenna (not shown). The transceiver 52 may be carried by the mattress 20 of the adjustable bed 10, by the adjustable foundation 60 of the adjustable bed 10, or elsewhere. In some embodiments, the transceiver 52 may be associated with (e.g., located adjacent to, packaged with, etc.) the processor 50 of the adjustable bed 10.

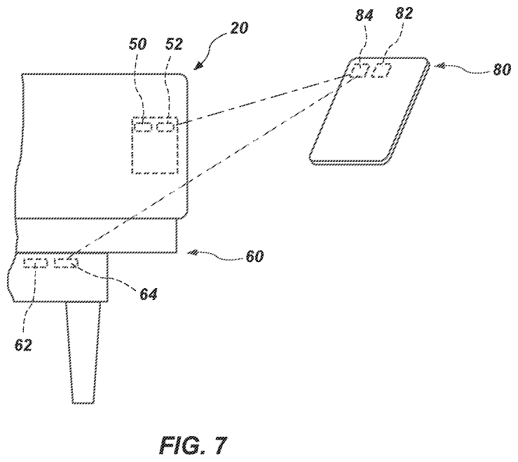

The at least one wireless transceiver 52 may be associated with, or communicate with, the main processor 50 of the adjustable bed 10. The wireless transceiver(s) 52 may be associated with the main processor 50 in a manner that enables signals (e.g., data, programming, etc.) to be communicated to and from the main processor 50. More specifically, the wireless transceiver(s) 52 may be associated with the main processor 50 in a manner that enables the main processor 50 to communicate with another electronic device. For example, as shown in FIG. 7, a wireless transceiver 52 may communicate with a wireless transceiver 64 of the adjustable base 60 through respective antennas to establish communication between the main processor 50 of the adjustable bed 10 and a processor 62 of the adjustable base 60. As another example, as shown in FIG. 7, the wireless transceiver 52 may communicate with a wireless transceiver 84 of a portable electronic device 80 (e.g., a smart phone, a tablet computer, a smart watch, etc.) through respective antennas to establish communication between the main processor 50 of the adjustable bed 10 and a processor 82 of the portable electronic device 80.

With reference to FIGS. 5 and 6, the adjustable base 60 may include a platform 61 that carries the mattress 20 (FIG. 1). The platform 61 may include a plurality of movable sections 61H, 61I, 61F. In addition, as shown in FIG. 6, the adjustable base 60 includes the processor 62, electronics 63 associated with the processor 62, at least one wireless transceiver 64 and an associated antenna associated with the processor 62, and at least one motor 65 that drives pistons 66, control arms, or the like to move the various movable sections 61H, 61I, 61F of the platform 61.

Each movable section 61H, 61I, 61F of the platform 61 of the adjustable base 60 may be oriented in a desired manner. Each movable section 61H, 61I, 61F may include an edge 61e that is associated (by way of one or more hinges, etc.) with an adjacent edge 61e of an adjacent movable section 61H, 61I, 61F. Thus, movement of one movable section 61H, 61I, 61F to a desired orientation may affect an orientation of at least one other movable section 61H, 61I, 61F.

The electronics 63 of the adjustable base 60 may receive power from a power supply (e.g., mains power, etc.) in a manner known in the art and communicate the power in a manner that enables other components of the adjustable base 60 to function (e.g., the processor 62, the transceiver(s) 64 and associated antenna(s), the motor(s) 65, etc.). The processor 62 and the electronics 63 of the adjustable base 60 may control operation of other components of the adjustable bed 60 (e.g., the motor(s) 65, etc.).

The processor 62 of the adjustable base 60 may comprise one or more processing elements of a suitable type. In some embodiments, the processor 62 may comprise one or more microcontrollers, which may execute embedded programming (e.g., firmware) to control one or more dedicated functions. The processor 62 may be carried by the electronics 63 of the adjustable base 60.

The at least one wireless transceiver 64 of the adjustable base 60 may comprise one or more of a WiFi transceiver, a Bluetooth® transceiver, a near-field communication (NFC) (e.g., RF, etc.) transceiver, a 2.4 GHz RF transceiver, or the like, along with an associated antenna. In embodiments where the processor 62 of the adjustable base 60 is carried by the electronics 63 of the adjustable base 60, a wireless transceiver 64 may also be carried by the electronics 63.

The at least one wireless transceiver 64 may be associated with, or communicate with, the processor 62 of the adjustable base 60 in a manner that enables signals (e.g., data, programming, etc.) to be communicated to and from the processor 62. More specifically, the wireless transceiver(s) 64 may be associated with the processor 62 in a manner that enables the processor 62 to communicate with another electronic device. For example, a wireless transceiver 64 may communicate with the wireless transceiver 52 of the adjustable bed 10 through respective antennas to establish communication between the processor 62 of the adjustable base 60 and the main processor 50 of the adjustable bed 10. As another example, the wireless transceiver 64 may communicate with a wireless transceiver 84 of a portable electronic device 80 (e.g., a smart phone, a tablet computer, a smart watch, etc.) through respective antennas to establish communication between the processor 62 of the adjustable base 60 and a processor 82 of the portable electronic device 80.

The motor(s) 65 of the adjustable base 60 may move the movable sections 61H, 61I, 61F of the platform 61 of the adjustable base 60 to desired orientations. Together, the motor(s) 65 and the platform 61 move sections 32′, 34′, 36′ of the mattress 20 to desired orientations, placing the mattress 20 in a desired arrangement. Operation of the motor(s) 65 and, thus, movement of the movable sections 61H, 61I, 61F may be controlled by the processor 62 and electronics 63 of the adjustable base 60.

Turning now to FIG. 7, the processor 82 of the portable electronic device 80 may execute a bed control app, which may enable an individual to use the portable electronic device 80 to control operation of the adjustable bed 10.

Communication between the portable electronic device 80 and the adjustable bed 10 may be established in any suitable manner. For example, as the bed control app is opened, or executed, by the portable electronic device 80, the bed control app may initiate communication between the processor 82 of the portable electronic device 80 and the main processor 50 of the adjustable bed 10 and/or the processor 62 of the adjustable base 60. As another example, a switch in the bed control app may enable it to initiate communication between the processor 82 of the portable electronic device 80 and the main processor 50 of the adjustable bed 10 and/or the processor 62 of the adjustable base 60. As yet another example, the main processor 50 of the adjustable bed 10 may be programmed to wake the processor 82 of the portable electronic device 80 and, thus, wake the portable electronic device 80 as the adjustable bed 10 (e.g., a sensor, etc., of the adjustable bed 10) detects the presence of the portable electronic device 80 or the individual in proximity to the mattress 20 and/or detects the presence of an individual on the sleep surface 24 of the mattress 20. Upon being awakened, the processor 82 of the portable electronic device 80 may initiate execution of the bed control app.

The bed control app may enable a user to set a pressure (e.g., a single pressure, an orientation-dependent pressure, etc.) for each pressurizable section 32, 34, 36 of the pressurizable layer 30 of the mattress 20 (FIGS. 2 and 3), determine the extent to which (if any) the pressure changes as an orientation of each corresponding section 32′, 34′, 36′ (FIGS. 2 and 3) of the mattress 20 changes (e.g., between a reclined orientation and an inclined orientation, etc.), and/or program one or more arrangements (i.e., orientations of sections 32′, 34′, 36′ of the mattress 20 and corresponding pressures of pressurizable sections 32, 34, 36 of the pressurizable layer 30 within the mattress 20), among controlling other functions of the adjustable bed 10.

In addition, the bed control app may enable an individual to use the portable electronic device 80 to control operation of the adjustable bed 10. More specifically, the bed control app may cause the processor 82 of the portable electronic device 80 to communicate with the main processor 50 of the adjustable bed 10 (by way of transceivers 84 and 52 and their respective antennas) in a manner that controls operation of the adjustable bed 10. For example, the bed control app may cause the processor 82 of the portable electronic device 80 to communicate with the main processor 50 of the adjustable bed to: (1) communicate with the processor 62 of the adjustable base 60 (by way of transceivers 52 and 64) to control movement of the platform 61 of the adjustable base 60 and (2) control pressurization of one or more pressurizable sections 32, 34, 36 of the pressurizable layer 30 of the mattress 20. Alternatively, the bed control app may cause the processor 82 of the portable electronic device 80 to: (1) communicate directly with the processor 62 of the adjustable base 60 (by way of transceivers 84 and 64 and their respective antennas) to control movement of the platform 61 and (2) communicate with the main processor 50 of the adjustable bed 10 (by way of transceivers 84 and 52 and their respective antennas) to control pressurization of one or more pressurizable sections 32, 34, 36 of the pressurizable layer 30 of the mattress 20.

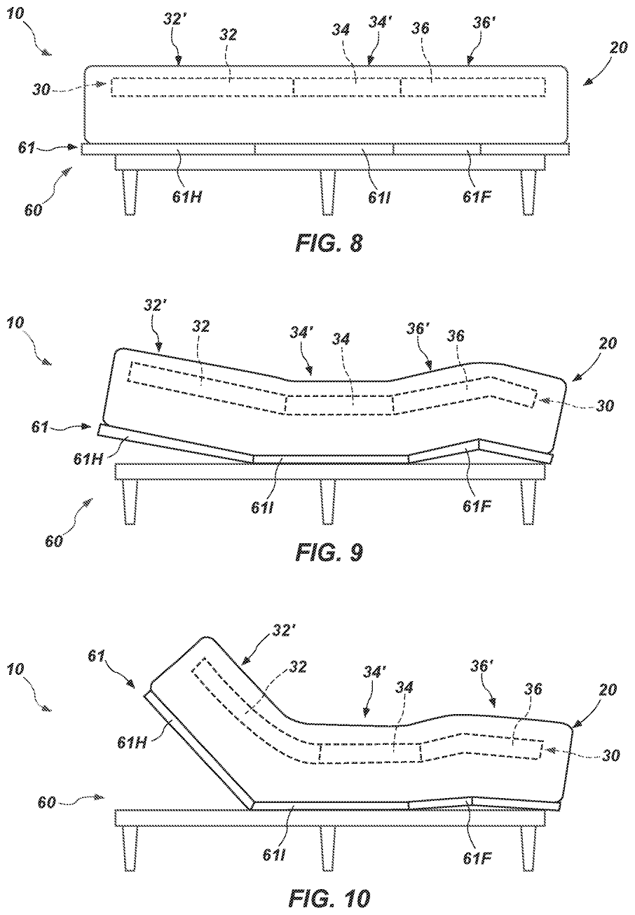

With reference now turned to FIGS. 8-10, pressurization of the pressurizable sections 32, 34, 36 of the pressurizable layer 30 of the mattress 20 of the adjustable bed 10 may be adjusted (e.g., automatically, manually, etc.) while changing orientations of the sections 32′, 34′, 36′ of the mattress 20 within which the pressurizable sections 32, 34, 36 of the pressurizable layer 30 are located. Automatic adjustment of one or more of the pressurizable sections 32, 34, 36 may be based on one or more adjustment factors (e.g., one or more algorithms, one or more lookup tables, etc.).

With added reference to FIG. 7, the main processor 50 of the adjustable bed 10 and/or the processor 82 of the portable electronic device 80 (e.g., under control of the bed control app, etc.) may cause(s) the processor 62 of the adjustable base 60 to change an orientation of, or move, one or more movable sections 61H, 61I, 61F of the platform 61 of the adjustable base 60 in a desired manner (e.g., in a manner input by a user, in a manner predetermined and/or preprogrammed by a user, in a predetermined or preprogrammed “preferred” manner determined by the processor 52, etc.). Adjustment of the orientation of one or more of the movable sections 61H, 61I, 61F may place at least one section 32′, 34′, 36′ of the mattress 20 in a desired orientation and/or place the mattress 20 in a desired arrangement (e.g., a flat, non-use arrangement, as shown in FIG. 8; a desired sleep arrangement, as shown in FIG. 9; a partially inclined arrangement, as shown in FIG. 10; etc.).

An orientation of one or more of the movable sections 61H, 61I, 61F may also be adjusted for any of a variety of other purposes, such as to reduce or eliminate snoring, leg movement (e.g., in restless leg syndrome, etc.), rolling, etc., by an individual, or for any other purpose that may facilitate restful sleep by an individual.

Alternatively, the adjustable base 60 may be adjusted independently of the bed control app (e.g., manually, automatically with an app that does not communicate with the bed control app, etc.).

Regardless of how the adjustable base 60 is adjusted, as each movable section 61H, 61I, 61F of the platform 61 of the adjustable base 60 moves and orients a corresponding section 32′, 34′, 36′ of the mattress 20, the main processor 50 (FIG. 7) of the adjustable bed 10 may control operation of the pressurization system 40 associated with the mattress 20 to adjust a pressure within one or more pressurizable sections 32, 34, 36 of the pressurizable layer 30 of the mattress 30. The pressure within the one or more pressurizable sections 32, 34, 36 may be adjusted to substantially maintain or maintain a predetermined pressure of the pressurizable sections(s) 32, 34, 36 and/or a feel of a corresponding section 32′, 34′, 36′ of the mattress 20. For example, as section 32′ of the mattress 20 is moved from the orientation shown in FIG. 8 to the orientation shown in FIG. 9 and from the orientation shown in FIG. 9 to the orientation shown in FIG. 10, pressures within its corresponding pressurizable section 32 of the pressurizable layer 30 and within the pressurizable section 34 within the adjacent section 34′ of the mattress 20 may increase; the pressures within the pressurizable sections 32 and 34 and/or the feel of the corresponding sections 32′ and 34′ of the mattress 20 may be maintained by removing controlled amounts of air from the pressurizable sections 32 and 34. Conversely, as the section 32′ of the mattress 20 is moved from the orientation shown in FIG. 10 to the orientation shown in FIG. 9 and/or from the orientation shown in FIG. 9 to the orientation shown in FIG. 8, pressures within the pressurizable sections 32 and 34 may decrease; the pressures within the pressurizable sections 32 and 34 and/or the feel of the corresponding sections 32′ and 34′ of the mattress 20 may be maintained by adding controlled amounts of air to the pressurizable sections 32 and 34.

In some embodiments, including those where the main processor 50 and/or the processor 82 of the portable electronic device 80 executing the bed control app communicates with the processor 62 of the adjustable base 60, the pressure within the one or more pressurizable sections 32, 34, 36 may be adjusted to an orientation-specific pressure.

The manner and extent to which the pressure of each pressurizable section 32, 34, 36 is adjusted (if at all) may be determined by the main processor 50 of the adjustable bed 10 or set with the bed control app executed by the processor 82 of the portable electronic device 80. Thus, the main processor 50 and/or the bed control app may synchronize pressurization of different pressurizable sections 32, 34, 36 of a pressurizable layer 30 of a mattress 20 of an adjustable bed 10 with an arrangement of the mattress 20 by an adjustable platform 60 of the adjustable bed 10.

In addition to adjusting pressure within one or more pressurizable sections 32, 34, 36 of the pressurizable layer 30 of the mattress 20 based on a change in the orientation of the corresponding section 32′, 34′, 36′ of the mattress 20, optionally based on a change in the orientation of an adjacent section 32′, 34′, 36′ of the mattress 20, and based on the extent(s) of the change(s) in orientation, the extent to which pressure within a pressurizable section 32, 34, 36 is adjusted may be based on additional criteria.

For example, the presence of an externally applied load to the corresponding section 32′, 34′, 36′ of the mattress 20 (e.g., from an individual lying on the mattress 20, from bedding on the mattress 20, from the presence of another object on a portion of the mattress 20, etc.) may be taken into account when determining the extent, if any, to which pressure within each pressurizable section 32, 34, 36 is to be adjusted when the orientation of at least one section 32′, 34′, 36′ of the mattress 20 changes. The pressure within one or more pressurizable sections 32, 34, 36 may also be adjusted when an external load is applied to or removed from the mattress 20 regardless of whether an orientation of the corresponding section 32′, 34′, 36′ of the mattress 20 changes. The extent to which pressure within one or more pressurizable sections 32, 34, 36 changes based on the additional factor

As another example, an orientation of one or more movable sections 61H, 61I, 61F of the platform 61 of the adjustable base 60 and/or an extent to which one or more of the movable sections 61H, 61I, 61F is moved may be considered in determining whether to adjust the pressure within each pressurizable section 32, 34, 36 of the pressurizable layer 30 of the mattress and/or the amount the pressure within each pressurizable section 32, 34, 36 is adjusted, if at all. Movement of one or more movable sections 61H, 61I, 61F may correlate with pressure changes in the pressurizable sections 32, 34, 36 of the pressurizable layer 30 of the mattress 20 The correlation may be direct, for example, when each section 32′, 34′, 36′ of the mattress 20 is aligned with a corresponding movable section 61H, 61I, 61F of the platform 61, etc. The correlation may be indirect, for example, when one or more sections 32′, 34′, 36′ of the mattress 20 is not aligned with a corresponding movable section 61H, 61I, 61F of the platform 61, is positioned over adjacent portions of two or more moveable sections 61H, 61I, 61F of the platform 61, etc.

It should be appreciated by those of ordinary skill in the art that pressurization of one or more pressurizable sections 32, 34, 36 of the pressurizable layer 30 of the mattress 20 may be impacted by movement of a movable section 61H, 61I, 61F of the platform 61 that is not located beneath the pressurizable section 32, 34, 36. For example, movement of a pressurizable section 61F located beneath a portion 36′ of the mattress 20 that receives an individual's legs and/or feet may affect pressurization of a pressurizable section 32 within the portion 32′ of the mattress 20 where the individual may rest their head. Accordingly, movement of the movable section 61F may result in an adjustment to the pressure within the pressurizable section 32 (e.g., to maintain a pressure and/or feel of the portion 32′ of the mattress, etc.). Thus, in some embodiments, a pressure within any pressurizable section 32, 34, 36 may be adjusted based movement of any of the moveable sections 61H, 61I, 61F of the platform 61.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. A bed, comprising:
an adjustable base including movable sections; and
a mattress on the adjustable base and including air bladders with independent inflation states; and
a processor that controls pressurization of each air bladder of the air bladders of the mattress based on position of the movable sections of the adjustable base.

2. The bed of claim 1, wherein the movable sections of the adjustable base include a body section and at least one leg section.

3. The bed of claim 2, wherein the air bladders of the mattress include a body air bladder and at least one leg air bladder.

4. The bed of claim 2, wherein the at least one leg section of the adjustable base includes an upper leg section and a lower leg section that move relative to each other.

5. The bed of claim 4, wherein the air bladders of the mattress include a body air bladder, an upper leg air bladder, and a lower leg air bladder.

6. The bed of claim 1, wherein the processor controls an amount of air within each air bladder to maintain a pressure of each air bladder upon movement of at least one movable section of the movable sections of the adjustable base.

7. The bed of claim 1, wherein the processor adjusts an amount of air within at least one air bladder of the air bladders of the mattress to place the air bladders of the mattress in preprogrammed pressurized states corresponding to positions of the movable sections of the adjustable base.

8. The bed of claim 1, further comprising:
a pressurization system.

9. The bed of claim 8, wherein the processor automatically controls operation of the pressurization system.

10. A bed, comprising:
an adjustable base including movable sections; and
a mattress on the adjustable base and including air bladders, each air bladder of the air bladders substantially corresponding to a movable section of the movable sections of the adjustable base, each air bladder of the air bladders being pressurizable independently from every other air bladder of the air bladders; and
a processor that controls pressurization of each air bladder of the air bladders of the mattress based on position of the movable sections of the of the adjustable base.

11. The bed of claim 10, wherein the processor controls the pressurization of each air bladder to maintain a pressure of each air bladder upon movement of at least one movable section of the movable sections of the adjustable base.

12. The bed of claim 10, wherein the processor adjusts the pressurization of at least one air bladder of the air bladders of the mattress to place the air bladders of the mattress in preprogrammed pressurized states corresponding to positions of the movable sections of the adjustable base.

13. The bed of claim 10, further comprising:
a pressurization system.

14. The bed of claim 13, wherein the processor controls operation of the pressurization system.

15. The bed of claim 14, wherein the processor is programmed to automatically adjust a pressure within at least one air bladder of the air bladders in response to a change in orientation of the mattress and/or movement of at least one movable section of the movable sections of the adjustable base.

16. The bed of claim 15, wherein the processor is programmed to substantially maintain a pressure within each air bladder of the air bladders in response to the change in orientation of the mattress and/or movement of at least one movable section of the movable sections of the adjustable base.

17. A method for pressurizing an adjustable bed, comprising:
moving a position of at least one movable section of an adjustable bed frame; and
controlling a pressure within at least one air bladder of a mattress carried by the adjustable bed frame in a manner that corresponds to the position in which the at least one movable section of the adjustable bed frame is moved.

18. The method of claim 17, wherein controlling the pressure comprises maintaining a pressure of each air bladder of the mattress upon movement of the at least one movable section of the adjustable bed frame.

19. The method of claim 17, wherein controlling the pressure comprises adjusting the pressurization of at least one air bladder of the air bladders of the mattress to place the air bladders of the mattress in preprogrammed pressurized states corresponding to positions of the movable sections of the adjustable base.

20. The method of claim 17, wherein controlling the pressure within the at least one air bladder comprises automatically controlling the pressure within the at least one air bladder.
